(19) United States
(12) Patent Application Publication
(10) Pub. No.: US 2025/0132402 A1
(43) Pub. Date: Apr. 24, 2025

(54) CONTROL DEVICE FOR A BATTERY SYSTEM

(71) Applicant: ELRINGKLINGER AG, Dettingen/Erms (DE)

(72) Inventors: Lars WELLER, Dettingen/Erms (DE); Joachim BUCK, Dettingen/Erms (DE); Yannick SCHWARZ, Dettingen/Erms (DE)

(21) Appl. No.: 18/688,219

(22) PCT Filed: Aug. 1, 2022
(86) PCT No.: PCT/EP2022/071605

§ 371 Date: Feb. 29, 2024

(30) Foreign Application Priority Data
Sep. 1, 2021 (DE) 10 2021 122 664.3

(51) Int. Cl. H01M 10/42; H01M 10/48

(52) U.S. Cl. CPC H01M 10/425; H01M 10/482; H01M 2010/4271; H01M 2010/4278

(57) ABSTRACT

A control device having a control unit for a battery system that has a number of storage cells, which are connected to a control unit and also to one another, wherein each of the storage cells is assigned a cell supervision circuit having connected sensors. In order to eliminate disadvantages in scalability and achieve the most accurate possible control and monitoring even for a large battery system, it is proposed to provide subgroups of interconnected storage cells and/or modules within the battery system, with each subgroup having a respective micro-master to which all of the cell supervision circuits of the relevant subgroup are connected and the micro-master being embodied to evaluate and filter all of the data from the cell supervision circuits and being connected to a battery management system by means of the control unit for the data transfer.

### FIELD OF THE INVENTION

The present invention relates to a control device for a battery system, which has a number of storage cells and/or modules, which are connected to a control unit and also to one another.

### BACKGROUND OF THE INVENTION

These days, battery systems are found on the market for drive systems in ever-increasing numbers, particularly for modern automobiles ranging from passenger cars to commercial vehicles and trucks, but also in stationary applications. It is known from the prior art that battery systems based on elementary battery cells are constructed very differently due to very different requirements for their electrical performance. In order to avoid the need for a completely new design for each new application, scalable HV batteries have been developed, for which quite a few cell-to-pack technologies, CTP for short, have also been proposed in recent years as a means for optimizing the power density of a battery pack. This trend is continuing with a cell-to-chassis approach, CTC for short, in which battery cells are arranged directly in a chassis instead of in a shared housing in a vehicle floor. This at least partially eliminates the need for heavy housings and sub-housings for combining elementary battery cells into modules so that with an appropriate interconnection, comparatively greater numbers of battery cells fit into the same installation space. Because of the above-mentioned approaches, the battery modules have grown into so-called packs, with a number of high-voltage components such as contactors also being optimized for a battery system consisting of several packs, thus making it possible to significantly reduce the overall number thereof.

The object of the present invention is to mitigate the disadvantages that arise in the context of the technology trends outlined above, particularly with regard to a control unit architecture and the complexity thereof, by means of a control device in a battery system of the above-mentioned type.

Currently, the cells in a pack are monitored, for example, via a CAN bus in the same way as a connection of a pack controller to a battery management system (BMS) is regulated via a CAN bus. A known control unit architecture and control unit communication therefore inherently have fundamental disadvantages that set technical limits on a free scalability and on a large increase in the size of a pack in terms of the number of elementary storage cells contained therein. With very high numbers of storage cells in a battery system, sampling rates of the cell sensors must be increasingly throttled in order to be able to continue handling the data traffic of the control unit communication. This inevitably reduces the accuracy of algorithms for determining a particular cell state.

### SUMMARY OF THE INVENTION

The above-stated object is attained according to the invention by subgroups of interconnected storage cells and/or modules that are provided within the battery system, with each subgroup having a respective micro-master to which all of the cell supervision circuits of the relevant subgroup are connected and with each cell supervision circuit CSC being embodied to evaluate cell voltages and temperatures by means of connected sensors for each storage cell, these cell supervision circuits CSC being embodied to send the supervision data to a micro-master and each micro-master being embodied to evaluate and filter all of the evaluation data of the connected cell supervision circuits CSC. For the data transfer, each micro-master is connected to a battery management system by means of the control unit.

Despite high sampling rates of a cell sensor system provided in each cell and/or each module and a the resulting continuously accurate supervision of each state, one approach according to the invention reduces a data quantity to a respectively required degree by means of evaluation and filtering in the respective micro-masters from one stage to the next of the interconnection or networking since only relevant information is passed on, which means significant deviations from an average value. This pre-processing of the data quantities with evaluation and filtering allows a total number of elementary storage cells to be significantly increased even when supervising each individual cell in a battery system, without overloading an associated battery management system (BMS) with a flood of data. This approach makes it possible to flexibly achieve very large battery systems with free spatial distribution. A division into subgroups of a kind with networking via data lines with upstream filtering of the data quantities by means of micro-masters contributes to equalization and also enables largely flexible interconnection of these subgroups, even with different sizes, to form a battery system that is centrally monitored and controlled in all operating states.

Accordingly, the cell supervision circuits are embodied as slaves for sending the supervision data to the associated micro-master via a data line. In one embodiment of the invention, this data line between the cell supervision circuits for sending the supervision data to the micro-master is embodied as a ring circuit. This ring circuit is advantageously embodied as bidirectional so that among other things, a simple interruption of the data line does not lead to a complete failure of the data forwarding.

In a particularly preferred embodiment of the invention, in each of the modules, an electrical isolation of the data lines and bus lines at a low-voltage level from the high-voltage level of the respective storage cells and their interconnection is provided. Preferably, this electrical isolation takes place in the cell supervision circuits. Alternatively or in addition, in one embodiment of the invention, an isolation barrier between the high-voltage level and the low-voltage level is created, which is located inside the micro-masters.

While a cell supervision circuit CSC represents a rigid microelectronic circuit which, as a slave, merely collects and forwards predetermined data from sensors on or in the elementary storage cells, among other things, a micro-master as an intermediate layer represents a data pre-processing instance that is advantageously equipped with its own software and is interposed in a chain of data forwarding from the cell supervision circuits CSCs to the battery management system BMS serving as the actual control unit. This means that in addition to the battery management system BMS with or in the actual control unit, the micro-masters are advantageously also updatable, preferably by importing updated software from an external source. Thus according to the invention, the control device is hierarchically embodied as a number of interconnected signal and data processing devices distributed across separate levels, i.e. over separate sub-instances. By introducing an intermediate level with micro-master units, the control device is now scalable and adaptable to the respective size of a battery system in a way that would never have been technically feasible using known approaches. This also makes it possible for a largely freely selectable number of differently structured subgroups to be managed and monitored by the control device since one micro-master per subgroup of interconnected storage cells is provided for an electrical adaptation and a reduction of the data to a minimum. The storage cells in this case can be elementary storage cells or a group of permanently interconnected elementary storage cells.

Advantageously, the data line for sending the supervision data to the micro-master is embodied as a bidirectional ring bus. Preferably, a two-wire bus is provided here, which is particularly embodied as an unshielded twisted pair or UTP cable.

In a preferred embodiment of the invention, the isoSPI protocol is used on the two-wire data line. This provides electrical isolation, particularly in each of the modules. This electrical isolation of the data lines from the high-voltage level protects all of the signal processing components. This embodiment of the invention thus comprises, as an advantageous modification of the invention, the use of a master unit which, in the form of the battery management system BMS, receives pre-filtered data from an upstream level in the form of one micro-master per module from a certain number of electrical storage cells with a correspondingly reduced data rate on a robust bus for processing.

In one embodiment of the invention, the battery management system BMS, as a component of a high-voltage junction box, is connected to at least one unit of storage cells via connectors for high voltage and low voltage. When there are several units of storage cells, their electrical interconnection to one another can be freely embodied as a mixture of series and parallel connections to represent a predetermined voltage level at a set current. The high-voltage junction box is always connected via separate connections or high-voltage and low-voltage connectors to this interconnection of elementary storage cells on the high-voltage side and to a data communication on the low-voltage side. On the one hand, this separation by means of plugs enables quick replacement in the event of a defect, but on the other hand it also allows almost any configuration of units, with variations in type, structure, and wiring to be connected to the high-voltage junction box without overloading the battery management system BMS due to an excessive amount of data from the respective units.

### BRIEF DESCRIPTION OF THE DRAWINGS

Features and advantages of embodiments according to the invention will be explained in greater detail below with reference to exemplary embodiments and based on the drawings. In the schematic depictions in the drawings:

FIG. 1: shows a diagram of an exemplary embodiment of a control device for a battery system;

FIG. 2: shows the exemplary embodiment from FIG. 1 in a modification to enhance the battery system;

FIG. 3: shows the exemplary embodiment from FIG. 2 in a modification to depict another type of enhancement of the battery system; and

FIG. 4: is an alternative depiction of a battery system.

### DETAILED DESCRIPTION OF THE INVENTION

The same reference numerals are always used for the same elements or method steps throughout the various depictions in the drawings. Without limiting the invention, only one use of exemplary embodiments of the invention will be shown and described below based on a use in a passenger vehicle in the form of a car. It is, however, evident to a person skilled in the art that a control device described below can also be adapted in the same way to other vehicles such as aircraft or ships propelled by electric motors, as well as to stationary applications such as power supply.

According to the prior art, there are technical limits to the free scalability of battery systems and a large increase in the size of a pack in terms of the number of elementary storage cells it contains, partly due to known control devices. In a battery system with a very high number of storage cells, the sampling rates of the cell sensors must be increasingly throttled in order to be able to continue handling data traffic in a battery management system. An inevitably reduced sampling rate due to an increasing number of storage cells to be supervised also basically entails a reduction in the accuracy and reliability of algorithms that are used to determine and update a respective state of a respective cell based on these sampling data. Thus, the base values for the cell's state of charge SOC and state of health SOH become progressively less accurate.

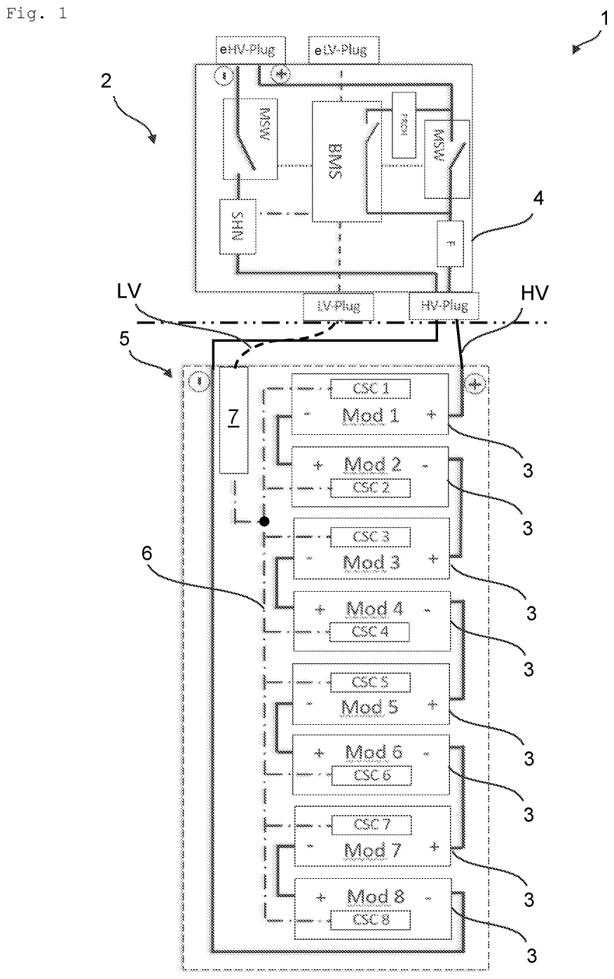

FIG. 1 is a diagram of an exemplary embodiment of a battery system 1 with a control device 2, which will now be described as a solution to the above-described problem of decreasing accuracy and reliability of a control device 2 for cell supervision with ever-increasing numbers of elementary cells 3 or modules Mod in a battery system 1. In a solution according to the invention, the development and production costs are also reduced when adapting to differently constructed and/or dimensioned battery systems 1.

In a high-voltage junction box or HVJB 4, the battery system 1 has separate connectors, eHV-Plug for high voltage HV and eLV-Plug for low voltage LV and data lines, respectively. In addition to a battery management system BMS operated on the low-voltage level LV, which is connected via a bus system to analog controls of contactors MSW and to the processing of the values of a measuring shunt SHN, including the values for temperature and charge of connected elementary storage cells 4, the high-voltage junction box 4 also houses the measuring shunt SHN and contactors MSW for both polarities of the high-voltage level as well as at least one fuse F for preventing electrical overload.

In this exemplary embodiment, the high-voltage junction box 4 is connected to an electrical unit 5 across a physical boundary via separate connectors, HV-Plug for high voltage HV and LV-Plug for low voltage LV. The unit 5 is formed by an electrical series circuit, for example composed of eight modules Mod 1 to Mod 8 in this instance. These modules Mod i shown here can also be elementary storage cells 4, each of which has its own cell supervision circuit CSCᵢ for determining the temperature and voltage of a relevant module Mod i. Each cell supervision circuit CSC is embodied as an unchangeable circuit in the form of a semiconductor chip and is used for a defined collection of predetermined data such as voltage and temperature from sensors connected to it. These measurement data are then transmitted to a micro-master 7 serving as the higher-level controller of the unit 5 via a bus 6, in this case via an ISO-SPI bus. The bus 6 is depicted here in a simplified star structure, but is in reality embodied as a ring bus, as described in greater detail below. In the micro-master 7, these data from the eight cell supervision circuits CSC1-CSC8 of this unit 5 are filtered with the aim of reducing the data and concentrating on a small amount of significant or important data. This means that not all of the data determined by the cell supervision circuits CSC1-CSC8 of all of the modules of the unit 5 are transmitted from the unit 5 via a CAN, KI15, or KI30c bus to a battery management system BMS by means of the low-voltage interface implemented via connectors. This pre-processing and filtering in the micro-master 7 leads to a significantly reduced amount of data and a greatly reduced load on the battery management system BMS.

A cell supervision circuit CSC is a rigid circuit that merely collects and forwards predetermined data from sensors, among other things. A micro-master 7, on the other hand, constitutes a pre-processing instance with its own software, which is interposed in a chain of data forwarding from the cell supervision circuits CSCi to a battery management system BMS serving as the actual control unit within the control device 2. In addition to the battery management system BMS, each micro-master 7 is also updatable.

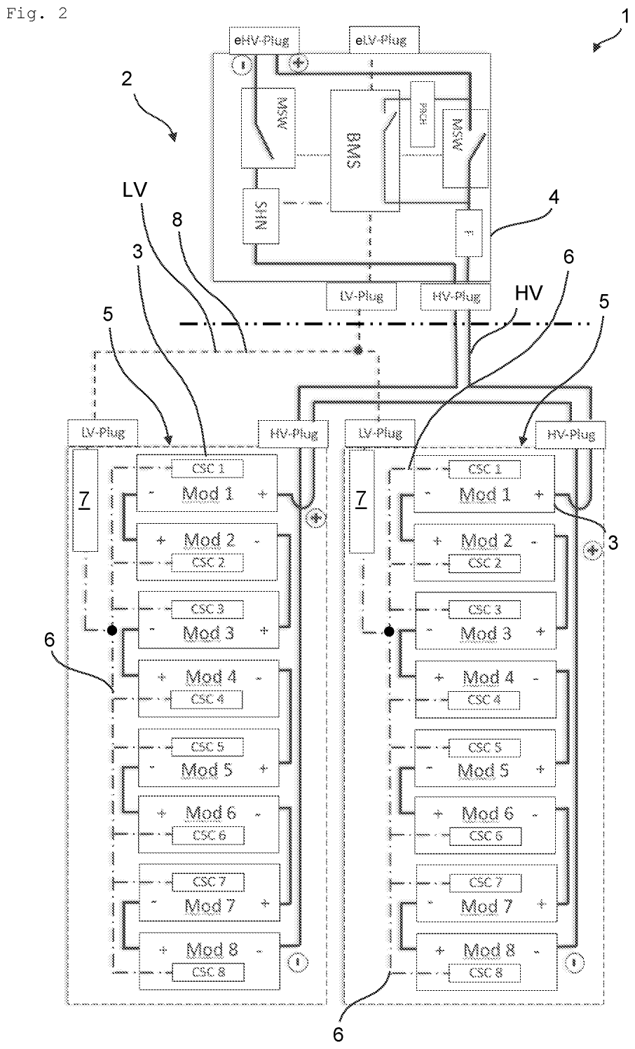

Thanks to the structure described above, the two parts, i.e. the high-voltage junction box 4 and the unit 5, are separate units that are connected to each other via connectors. In the event of a defect, these parts can therefore be replaced quickly and independently of each other. The actual advantage of this design, however, becomes clear from the illustration in FIG. 2, which shows a modification of the exemplary embodiment from FIG. 1 for enhancing the battery system 1. For this purpose, a series connection of internally identical units 5, for example two of them in this instance, on the other side of a physical boundary indicated by a dashed line has been connected to the high-voltage junction box 4 described in conjunction with FIG. 1 via separate connectors HV-Plug for high voltage HV and LV-Plug for low voltage LV and data lines, respectively.

Within the battery system 1, the units 5 constitute subgroups of interconnected storage cells 3 or, in another exemplary embodiment, modules Mod, with each subgroup 5 having a respective micro-master 7 for evaluating cell voltages and temperature by means of connected sensors, which are connected to the respective cell supervision circuits CSC. The micro-master 7 is embodied to evaluate and filter all of the data from the cell supervision circuits CSC, eight of them in this instance, and is connected to a battery management system BMS via a data line 8. A pre-processing of the respective measurement data of each CSC in the associated micro-masters 7 of each of the two units 5 in this instance advantageously does not lead to a duplication of the data thanks to a filtering with a focus on deviations or other predefined abnormalities. Through the pre-processing of all of the measurement data, only data that have been filtered out as relevant and/or have been pre-processed are forwarded to the battery management system BMS in the once again only one control device 2 for processing, thus significantly reducing the amount of data.

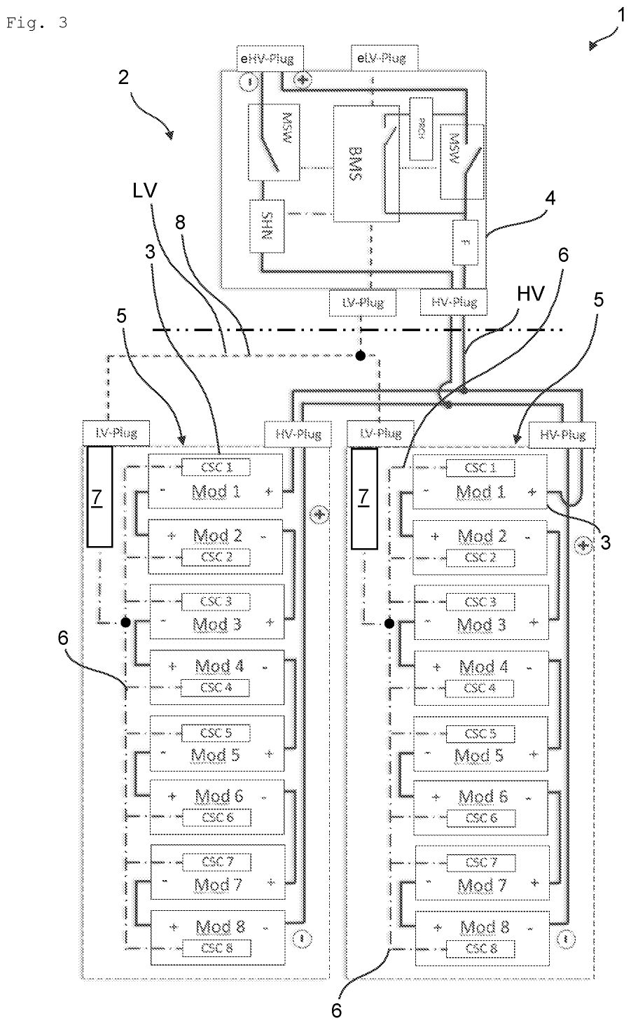

FIG. 3 shows the exemplary embodiment from FIG. 2 in a modification to depict another type of enhancement of the battery system 1. In this case, a parallel connection of two units 5 on the other side of the physical boundary has been connected to the high-voltage junction box 4 described in conjunction with FIG. 1, which remains unchanged, via the separate connectors HV-Plug for high voltage HV and LV-Plug low voltage LV. Once again, the pre-processing of the respective measurement data of each cell supervision circuit CSC in the associated micro-masters 7 of each of the two units 5 does not result in a proportional increase in the amount of data that has to be forwarded to the battery management system BMS and processed there. In this instance as well, only one battery management system BMS is required as a micro-controller in the control device 2 for the battery system 1 that has been enhanced in the manner described, which naturally also applies to more extensive enhancements and mixes of serial and parallel connections of units 5. The units 5 themselves are also embodied differently, among other things with regard to the number of cells 3 or modules Mod, so that new degrees of freedom are achieved here for optimizing the use of space.

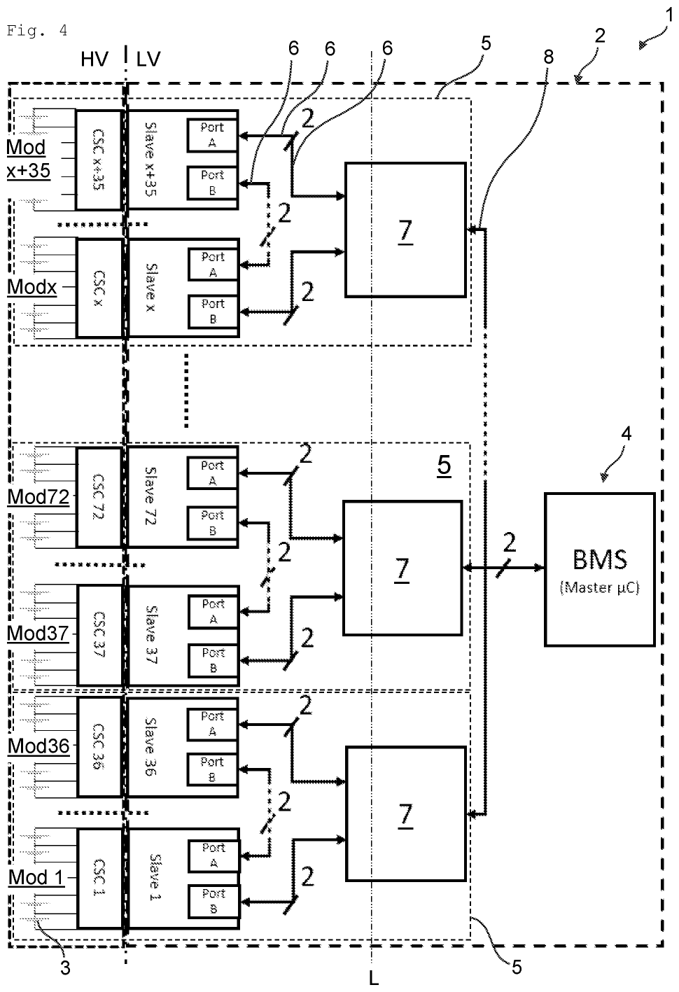

FIG. 4 is a simplified, alternative depiction of a battery system 1 emphasizing an internal structure of the bus 8 with a scalable number of ring bus systems 6 inside the control device 2, each extending from the battery management system BMS to a respective cell supervision circuit CSC of an elementary storage cell 3. Therefore, any type of electrical interconnection of the modules for providing a predetermined voltage level and current at external terminals or poles of the battery system 1 is disregarded in this illustration and omitted for the sake of clarity.

In this exemplary embodiment, six elementary cells 3 are each connected to a cell supervision circuit CSC to form a respective module Mod. Each cell supervision circuit CSC contains an isolation threshold for separating the high-voltage level HV from an adjacent low-voltage level LV and is embodied as a slave with two ports Port A, Port B on the other side of this isolation threshold, which is indicated by a dash-and-dot line. For data transmission, a micro-master 7 is connected to 36 cell supervision circuits CSC by means of a two-wire data line, which is embodied in the form of a bidirectional ring bus 6 in order to increase its reliability. This arrangement forms a subgroup 5. For the sake of clarity, only the first and last modules Mod with the associated cell supervision circuit CSC are shown. The micro-masters 7 each carry out a filtering and reduction of the sensor data that are continuously received from the respective 36 connected cell supervision circuits CSC, with updated values for temperature and voltage.

The micro-masters 7, as the head of their respective subgroup 5 so to speak, are connected to the battery management system BMS via an ISO SPI data line 8. The use of multiple micro-masters 7 makes it possible to keep the sampling rate of the sensors in the form of the cell supervision circuits CSC high since multiple micro-masters 7 then pre-filter the many data points and transmit only aggregated values to the battery management system BMS serving as the system master. The battery management system BMS then processes only aggregated values with a significantly reduced data quantity, but based on a very extensive sampling of numerous measuring points. This results in high accuracy and reliability of the respective cell states determined by algorithms and the updating thereof.

In a further exemplary embodiment, the isolation barrier is shifted from the region of the cell supervision circuits CSC to the micro-masters 7. This is indicated by the thinner dash-and-dot line L in FIG. 4. This step significantly reduces the number of decoupling elements required for the galvanic isolation between the high-voltage level HV and the low-voltage level LV.

It is not necessary to adapt the high-voltage junction box 4 to a changed number of subgroups 5 and/or to changes within the subgroups 5 because of the coupling of the battery management system BMS to the micro-masters 7 via the bus 8. The number of software-carrying components is reduced to the micro-masters 7 and the battery management system BMS. The development and subsequent administration and maintenance of the above-described control device 2 are facilitated by proprietary software for importing updates of the respective software to the above-mentioned components.

With flexible adaptability to any battery systems 1 structured in subgroups 5, the above-described control device 2 is characterized by the fact that no overloading of the battery management system BMS can occur due to an excessive amount of data from the respective subgroups 5. A pre-processing by the micro-master 7 in each subgroup 5 effectively reduces the voluminous measurement data to essential data, which are then forwarded for processing to the battery management system BMS with a control unit serving as a master uC.

As already demonstrated at the beginning, an approach according to the invention can be applied to a high-voltage battery system 1 in which subgroups 5 of interconnected storage cells 4 and/or modules Mod made up of a number of storage cells 4 are provided. The architecture described above is freely scalable without significant changes, with freely selectable interconnection of the subgroups 5 to one another. The functionality of the battery management system BMS of the HVJB is located outside the interconnected subgroups 5 and is connected to the interconnected subgroups 5 in a modular structure via connectors, HV-Plug for high voltage and LV-Plug low voltage.

1. A control device for a battery system, comprising:
a plurality of storage cells and/or modules connected to a control unit and also to one another, wherein each of the storage cells is assigned a cell supervision circuit having connected sensors,
wherein subgroups of the interconnected storage cells and/or modules are provided within the battery system, with each subgroup having a respective micro-master to which all of the cell supervision circuits of the relevant subgroup are connected and the micro-master being embodied to evaluate and filter, wherein the respective micro-master evaluates and filters all data from the cell supervision circuits and the respective micro-master is connected to a battery management system by the control unit for transferring the data.

2. The control device according to claim 1, wherein the cell supervision circuits send supervision data to the associated micro-master via a data line.

3. The control device according to claim 2, wherein the data line between the cell supervision circuits for sending the supervision data to the micro-master is embodied as a ring circuit.

4. The control device according to claim 3, wherein the data line is embodied as a bidirectional ring bus.

5. The control device according to claim 1, wherein in each of the modules, an electrical isolation of the data lines and bus lines at a low-voltage level from a high-voltage level of the respective storage cells and their interconnection is provided.

6. The control device according to claim 1, wherein an isolation barrier between a high-voltage level and a low-voltage level is provided, which is located inside the micro-masters.

7. The control device according to claim 1, wherein the micro-masters, the battery management system, and the control unit are updatable.

8. The control device according to claim 1, wherein the micro-masters are connected to the battery management system via an ISO SPI data line.

9. The control device according to claim 1, wherein the battery management system, as a component of a high-voltage junction box, is connected to at least one of the subgroups via connectors for high voltage and for low voltage.

10. The control device according to claim 5, wherein the electrical isolation of the data lines and bus lines at a low-voltage level from the high-voltage level of the respective storage cells and their interconnection is provided in the cell supervision circuits.
